(19) United States
(12) Patent Application Publication
(10) Pub. No.: US 2012/0078950 A1
(43) Pub. Date: Mar. 29, 2012

(54) Techniques for Extracting Unstructured Data

(75) Inventors: Parker Conrad, San Francisco, CA (US); Tarun Arora, Kent View Park (SG)

(73) Assignee: NVEST INCORPORATED, San Francisco, CA (US)

(21) Appl. No.: 12/894,134

(22) Filed: Sep. 29, 2010

(51) Int. Cl. G06F 17/30

(52) U.S. Cl. 707/769; 707/E17.014

(57) ABSTRACT

A technique for extracting unstructured data includes receiving a plurality of regular expressions and a given document. The regular expressions include a plurality of extensible grammar expressions for searching for a set of information. The regular expressions are then used to search the given document to determine if the unstructured data matches one or more of the extensible grammar expressions. If a match is determined, one or more set of information is extracted from the unstructured data using one or more heuristics.

### BACKGROUND OF THE INVENTION

Individuals, businesses and other entities utilize ever increasing amounts of information. The processing of information in one form another continues to an unprecedented extent with the use of computer systems. The data may be received in any number of forms and may be in a structured format, such as in tables, databases and the like. However, a substantial amount of data may be in an unstructured format. The information may be, for example, corporate financial statements, police reports, research reports, marketing reports and/or the like.

A corporate financial statement, for example, may include a textual description of the results and one or more tables of financial data. The statement may include the name of the corporation, the exchange that the corporation's stock is traded on, the exchange symbol, the financial reporting period (e.g., year and/or quarter), revenue, net income, earnings per share, performance for each of a plurality of divisions, future forecast, and/or the like. The conventional methods try to extract the data, such as income statements, balance sheets and/or the like, that appear to be structured data, from the tables of the financial statement. However, the tables are subject to a number of ambiguities. For example, the tables may not indicate the units, such as thousands or millions, whether the results are GAPP or non-GAPP, and/or the like.

In other conventional art techniques, the grammar of the sentence is analyzed. In particular, the techniques try to identify the nouns, verbs, adjectives and/or the like and try to apply a plurality of heuristics to extract the data from the sentences. However, such methods do not work very well for extracting data from sentences. In addition, such methods are relatively slow and are limited to being statistically correct. Accordingly, there is a continuing need for techniques for extracting unstructured data from documents.

### SUMMARY OF THE INVENTION

The present technology may best be understood by referring to the following description and accompanying drawings that are used to illustrate embodiments of the present technology.

Embodiments of the present technology are directed toward techniques for extracting information from documents including unstructured data. In one embodiment, a method includes receiving a plurality of extensible grammar expressions, wherein each extensible grammar expression includes a regular expression that searches for a set of information. The extensible grammar expressions are regular expressions that specify the allowed structures of sentences, the plurality of variables for matching and the order of the variables. The method also receives a given document including unstructured data. The received document is then tokenized. The tokenized document is searched using the regular expressions to determine if the unstructured data in the document matches one or more of the extensible grammar expressions. If a match is determined, one or more sets of information are extracted from the unstructured data using one or more heuristics.

In one embodiment, the regular expressions comprise a comprehensive list of sentences abstracted into a plurality of extensible grammar expressions based on allowed forms and variances of the sentences. In one embodiment, each extensible grammar expression includes calls to a plurality of variables joined by one or more regular expression operands. In one embodiment, each variable includes one or more functionally equivalent words and/or phrases joined by one or more regular expression operands. Each variable may also include calls to one or more other variables.

In one embodiment, the method may also include identifying the information to be extracted and receiving a plurality of candidate documents including unstructured data. The plurality of extensible grammar expressions are then generated from the plurality of candidate documents. The extensible grammar expressions are regular expressions that specify the allowed structures of sentences, the plurality of variables for matching and the order of the variables.

In another embodiment, one or more data structures may store a plurality of extensible grammar expressions, wherein each extensible grammar expression includes a regular expression to match corresponding unstructured data in a document. Each extensible grammar expression may include a extensible grammar expression identifier, a plurality of variables and regular expression operands. The one or more data structures may also store the plurality of variables, wherein each variable includes a variable identifier, one or more words, phrases and/or other variables identifiers, and one or more regular expression operands. The one or more data structures may also store one or more potential word tokens, wherein each word token includes a regular expression comprising one or more words, one or more phrases and one or more regular expression operands.

### BRIEF DESCRIPTION OF THE DRAWINGS

Embodiments of the present technology are illustrated by way of example and not by way of limitation, in the figures of the accompanying drawings and in which like reference numerals refer to similar elements and in which:

FIG. 1 shows a flow diagram of a method of generating a regular expression for extracting information from documents, in accordance with one embodiment of the present technology.

FIG. 2 shows a flow diagram of a method of extracting information from a document, in accordance with one embodiment of the present technology.

FIG. 3 shows a block diagram of an exemplary computing environment for implementing embodiments of the present technology.

FIG. 4 shows a block diagram of a regular expression setup module, in accordance with one embodiment of the present technology.

FIG. 5 shows a block diagram of a regular expression extraction module, in accordance with one embodiment of the present technology.

### DETAILED DESCRIPTION OF THE INVENTION

Reference will now be made in detail to the embodiments of the present technology, examples of which are illustrated in the accompanying drawings. While the present technology will be described in conjunction with these embodiments, it will be understood that they are not intended to limit the invention to these embodiments. On the contrary, the invention is intended to cover alternatives, modifications and equivalents, which may be included within the scope of the invention as defined by the appended claims. Furthermore, in the following detailed description of the present technology, numerous specific details are set forth in order to provide a thorough understanding of the present technology. However, it is understood that the present technology may be practiced without these specific details. In other instances, well-known methods, procedures, components, and circuits have not been described in detail as not to unnecessarily obscure aspects of the present technology.

Embodiments of the present technology advantageously extract information from documents including unstructured data. The techniques match on the order of hundreds of unique grammars for stating given information in sentence form. However, the extensible grammar expressions are highly abstracted and represent as much as 10 to the 100^{th} power of different unique sentences. Accordingly, the techniques can advantageously match a very large number of sentences with a far more limited number of extensible grammar expressions.

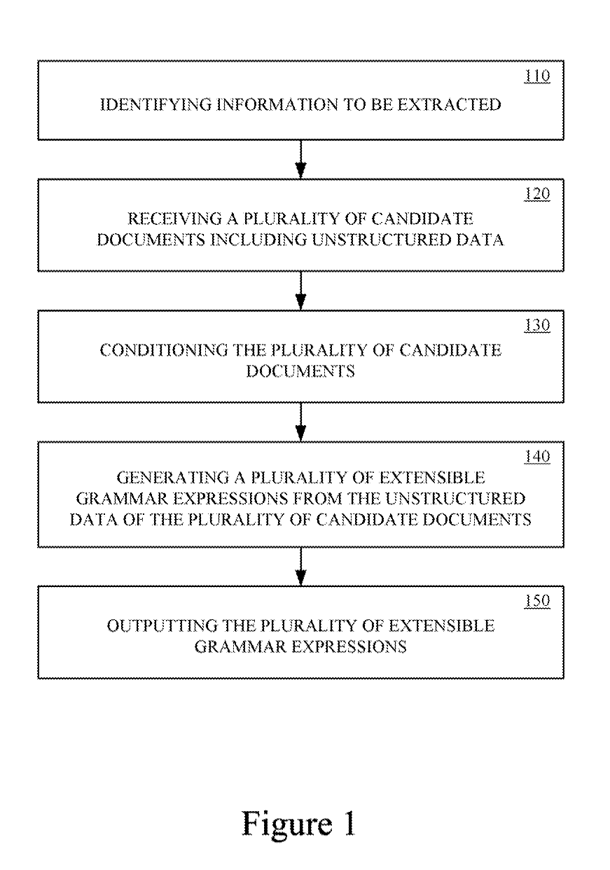

Referring to FIG. 1, a method of generating a regular expression for extracting information from documents, in accordance with one embodiment of the present technology, is shown. The method may begin with identifying information to be extracted, at 110. In an exemplary implementation, the information to be extracted may be financial data from corporate financial statements. For example, it may be desired to extract the name of the corporation, the exchange that the corporation's stock is traded on, the exchange symbol, the financial reporting period (e.g., year and/or quarter), revenue, net income, earnings per share, performance for each of a plurality of divisions, future forecast, and/or the like, from any of a number of corporate financial statements. It is appreciated that data in corporate financial statements may be written in a myriad of different possible sentences, using different grammatical structures and/or equivalent wording. Although embodiments of the present technology are described herein with reference to financial statements, it is appreciated that the embodiments may be readily adapted to extracting information from documents that include unstructured data, such as police reports, research reports, marketing reports and/or the like.

At 120, a plurality of candidate documents, each including unstructured data, are received. In one implementation, the candidate documents may be received in an extensible markup language (XML) format. The candidate documents are used to determine a comprehensive list of text strings that can be used to describe each piece of information to be extracted. For example, candidate corporate earnings reports may state that “Widgetco (NYSE:WID), a worldwide manufacturer and distributor of widgets, announces that revenue for the first quarter of 2009 was three million dollars,” “Acme announces that revenue during the first quarter of 2009 was eight million dollars,” “XYZ corporation's revenue during the quarter ending in March 2009 was $3,200,000” and the like. All of these sentences have the same basic grammatical structure that includes identification of the entity, the given period of time, and the amount of revenue. However, there may be hundreds, thousands or more possible grammatical structures, equivalent wording or combinations thereof for expressing the same information.

At 130, the process may optionally include conditioning the candidate documents. Conditioning may include application of one or more high-level rules, and/or stripping out a given set of punctuation and/or words. One or more high-level rules may include ignoring capitalization, replacing hyphens with spaces, and/or the like. One or more examples of stripping punctuation may include stripping out all commas, semicolons and/or the like. One or more examples of stripping words may include stripping out: slightly, partly, approximately, relatively, strong, only, nearly, substantially, dramatically, considerably, roughly, conservatively, about, around, marginally, primarily, partially, almost, essentially, more than and/or the like. The conditioning may be dependent upon the subject of the documents.

At 140, a plurality of extensible grammar expressions, for extracting the information, are generated. The extensible grammar expressions are generated as regular expressions including one or more variables of one or more variable types, one or more required and/or optional words, phrases and/or punctuations and one or more regular expression operands. The extensible grammar expressions are generated by determining the allowed forms and variance of sentences (e.g., structure and/or wording) for expressing the given information to be extracted. Generating the extensible grammar expressions may include generating a plurality of word substitution variables, replacing words and strings with the applicable word substitution variables, replacing parameter values with applicable parameter variables, and/or abstracting out optional and/or unnecessary words. The regular expression of the extensible grammar expressions may be written in a conventional language, such as Perl, hypertext preprocessor (PHP), C++, or a custom syntax. Each extensible grammar expression may be represented by a corresponding extensible grammar expression identifier. Each extensible grammar expression identifier may be a call to a respective extensible grammar expression.

Generating the word substitution variables may include determining corresponding sets of functionally equivalent words and/or phrases. The word substitution variables may each be a regular expression including the functionally equivalent words and/or phrases. A given word substitution variable may also include one or more other word substitution variables.

The regular expression of the word substitution variables may be written in a standard regular expression syntax or a custom syntax. For example, the description herein uses a custom syntax wherein each capitalized string in the extensible grammar expression is a variable. In one implementation, each word substitution variable may be indicated by a unique all capitalized string (e.g., word substitution identifier). Lower case strings are the words themselves. Anything inside brackets represents optional strings. Anything inside parentheses separated by commas are optional, however at least one must be present. Anything in bold is required. The string “<start>” indicates the document or the sentence must start there. In one implementation the start may be judged by either a capital letter, or first letter excluding punctuation of a new line, or following a period. In another implementation, the “<start>” indicates the start of the press release, which is usually identified by the date line (e.g., “Newswire—August 16^{th}, 2010, 4 p.m.”). The “<start>” is used to specify the elements that are allowed in the first sentence of the press release. The string “<end>” in one implementation indicates a period must be present. Ellipsis in strings means anything within the same sentence. In other words, text could be present or not and it should not affect the match. The equivalent phrases may include required words, optional words, or the like. Each word substitution variable may include one or more other word substation variables. In addition, given words and/or phrases may be included in a plurality of word substitution variables.

Each word substitution variable may be represented by a word substitution variable identifier. Each word substitution variable identifier may be a call to a set of one or more words, phrases and/or other variables, having a corresponding equivalent function, expressed as a regular expression. A word substitution variable identifier may for example be “BECAUSE” and may include “as a result of,” “due to,” “because [of],” despite,” “even though,” and “although.” In another example, the word substation variable “FOR” may include “[(were, was)] [recognized] on,” “[(arising, resulting, resulted, arose)] from,” “[(were, was)], [recognized] for,” “in,” “of,” “[(were, was)] relat(ing, ed) to,” “[(were, was)] attribute(able, ed) to,” “[(were, was)] [recognized] with respect to,” “under,” and [(were, was)] contributed by.” In yet another example, the word substitution variable “ANNOUNCE_BUCKET” may include “ANNOUNCED,” “ANNOUNCES,” “(are, is) (happy, pleased) to ANNOUNCE,” and “(are, is) ANNOUNCING.”

To generate the extensible grammar expressions, the functionally equivalent words and/or phrases in the candidate documents are replaced with the corresponding word substitution variable. For example, in the corporate earnings report “Widgetco, a worldwide manufacturer and distributor of widgets, announces that revenue for the first quarter of 2009 was three million dollars,” the words and phrases “Widgetco,” “and,” “announces,” “revenue” and “for” may be replaced by the word substitution variables “COMPANY,” “ANNOUNCE_BUCKET,” “AND,” “METRIC” and “FOR” respectively. After inserting one or more word substitution variables, the candidate sentence would be “COMPANY, a worldwide manufacturer AND distributor of widgets, ANNOUNCE_BUCKET that METRIC FOR the first quarter of 2009 was three million dollars.” In one implementation a word substitution dictionary is used to determine which words in a sentence map to corresponding word substitution variables. As new word substitution variables are determined they are added to the word substitution dictionary. Similarly, the word substitution dictionary may be updated with changes to word substitution variables. If a given word maps to a plurality of word substitution variables, one or more key words in the sentence and/or one or more heuristic rules may be used to select the corresponding word substitution variable.

In addition, parameters, such as numbers, dates, time periods, and/or the like, may be replaced with an applicable parameter variable. In one implementation, each parameter variable may be indicated by a unique all capitalized string. For example, in the corporate earnings report Widgetco, a worldwide manufacturer and distributor of widgets, announces that revenue for the first quarter of 2009 was three million dollars,” the period “first quarter of 2009” may be replaced by the parameter variable “NVESTPERIOD,” and the value “three million” may be replaced by the parameter variable “NVESTAMOUNT.” After replacing the parameter values with the applicable parameter variables, the candidate sentence would be “COMPANY, a worldwide manufacturer AND distributor of widgets, ANNOUNCE_BUCKET that METRIC FOR the NVESTPERIOD was NVESTAMOUNT.”

Furthermore, the candidate documents including the word substitution variables and parameter variables may be compared to determine optional and/or unnecessary words and/or phrases. The optional and/or unnecessary words and/or phrases are abstracted to generate the grammatical structure of the candidate documents. Abstracting using regular expressions captures the allowed forms of the grammatical structures, while replacing words, phrases and values with variables captures the variances of the sentences.

Accordingly, the use of extensible grammar expressions and variables effectively separate the structure and order of the sentences from the words employed in the sentence. Separating the structure and order allows the plurality of extensible grammar expressions to encompass a large number of the permutations of the structures and variables to describe a larger set of documents than just the set of candidate documents.

At 150, the plurality of extensible grammar expressions are output. In one embodiment, the regular expressions of the plurality of extensible grammar expressions are stored on one or more computing device readable media along with the variables. For example, the regular expressions of the extensible grammar expressions and variables may be stored in one or more data structures in the memory (e.g., hard disk drive) of a computer.

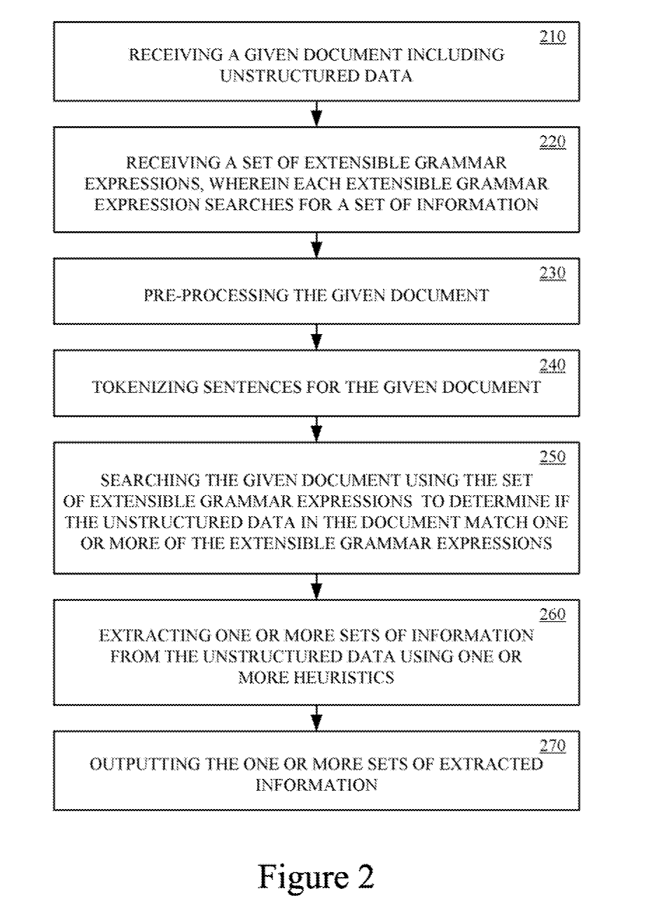

Referring now to FIG. 2, a method of extracting information from a document, in accordance with one embodiment of the present technology, is shown. The method may begin with receiving a document including unstructured data, at 210. In an exemplary implementation, the document may be an earnings press release pulled or pushed from a wire service. However, the document may be any type of document including unstructured data, such as a police report, research report, marketing report or the like. In one implementation, the document may be received in an extensible markup language (XML) format.

At 220, a set of extensible grammar expressions are received, wherein the regular expression of each extensible grammar expression is utilized to search for corresponding information. The set of extensible grammar expressions is a comprehensive list of sentences that could be included in a document abstracted into a plurality of grammatical structures based on the allowed forms and variances. In an exemplary implementation, the regular expressions of the set of extensible grammar expressions are utilized to search for financial information such as a company's stock symbol, the applicable exchange, the financial results such as revenue, net income, and the like for the current quarter and/or year.

The process may optionally include pre-processing the given document, at 230. Pre-processing may include replacing discrete values with recognized parameter tokens and storing the value of the parameter in metadata associated with the particular parameter token. For example, the values “three million” or “3,000,000” may be replaced by the parameter token “AMOUNT” in the sentence, and the metadata for the token may include the value of 3,000,000. Similarly, the “$” or “dollars” is replaced by CURRENCY in the sentence, and the metadata for the token includes the value of $US. Reporting periods, such as “Q4 2009” or “full year 2009” are replaced by PERIOD. In another implementation, the metadata may store a token to lookup the value in a data structure (e.g., table). For example, the date “Sep. 30, 2009,” may be replaced by the parameter variable “DATE” in the sentence, and the metadata for the token may be an index such as “253”, where “253” is used to lookup the date value for “DATE” in a table. It is appreciated that there may be multiple instance of each kind of parameter. Therefore there could be hundreds of individual currencies or dates, for example, listed in a given document. In one implementation, an ordinal number of each parameter (e.g., CURRENCY1, CURRENCY2, . . . CURRENCYn) may be stored. Thereafter, the values associated with each parameter may be looked up based on their ordering in the document.

At 240, the sentences in the given document are further tokenized by replacing one or more words with corresponding potential word tokens. As the mapping between words and potential word tokens is many-to-few, each sentence when words are tokenized creates a range of possible tokenized forms of the sentence which can be represented by a regular expression of tokens. Because the mapping of words to tokens is many-to-few (i.e., there are significantly fewer tokens that each word can belong to than there are words in any given token), the possibilities are much fewer and matching process can be much faster. By way of demonstration, the sentence “word1 word2 word3 word4 word5 word6” might be represented by tokenized regular expression “TOKEN1 (TOKEN2 TOKEN3|TOKEN4) TOKEN5”, where either “TOKEN2 TOKEN3” or “TOKEN4” could match a portion of the sentence. This tokenized regular expression is then matched against the set of extensible grammar expressions. If there is any overlap between these two regular expressions, a match is determined between the extensible grammar expression and the given sentence. Because each of the regular expressions of variables are modest in size, matching the tokenized sentences and extensible grammar expressions to each other may be performed very quickly.

In another embodiment, each of the extensible grammar expressions are expanded from the plurality of variables, at 240. Each extensible grammar expression may include a plurality of calls to variables arranged in permitted grammatical structures embodied by the regular expression operators. Each variable represents a call to a corresponding regular expression of required and/or optional words, phrases and/or other variables. Therefore, each variable is called to expand each extensible grammar expression to a regular expression all the way out until they are regular expressions of words, phrases and regular expression operators.

The tokenized given document is searched using the regular expressions of the set of extensible grammar expressions, at 250. The regular expressions are each interpreted by a text editor, a utility, program, or the like, to search and manipulate the tent of the tokenized given document based on patterns. The regular expressions are used to determine if unstructured data in the document matches one or more extensible grammar expressions. In one embodiment, the textual portions of the given document are searched using the one or more regular expressions.

In a multi-processing unit environment, each processor takes a different subset of extensible grammar expressions and matches the regular expression against each sentence or a subset of sentences within the tokenized document. For example, in a processing unit having four cores, the first core searches for a match between a first extensible grammar expression and the first sentence, a second core searches for a match between a second extensible grammar expression and the first sentence, a third core searches for a match between the first extensible grammar expression and a second sentence, and a fourth core searches for a match between the second extensible grammar expression and the second sentence, during a first processing pass. During a second pass, the first core searches for a match between the first extensible grammar expression and a third sentence, the second core searches for a match between the second extensible grammar expression and the third sentence, the third core searches for a match between the first extensible grammar expression and a fourth sentence, and the fourth core searches for a match between the second extensible grammar expression and the fourth sentence. The processing cores continue until each combination of extensible grammar expressions and sentences have been searched.

If a token in the given document matches a variable in a extensible grammar expression a candidate partial match is determined. After each combination of sentences and regular expressions have been analyzed for matches, the results are combined and checked for information that is shared across sentences. For example, sometimes the period of time for an instance of information to be extracted is actually present in the previous sentence. For example, the document may include the following sentences: “The Company announced Q4 2009 revenue was $5M. Net income was $2M.” In this case, the period of time for net income is present in the previous sentence and that information may be shared post parallelization. Similarly, things happen with, for example, the segment associated with specific data, as in “Revenue for our automobile segment was $5M. Operating income was $2M. In this case the $2M figure refers to the automobile segment and not the corporation's total operating income.

In the embodiment where each extensible grammar expression is expanded all the way out until they are regular expressions of words, the words and phrases in the extensible grammar expressions, as arranged according to the regular expression operators of the extensible grammar expression, are matched to the given document (e.g., un-tokenized document), at 250. Accordingly, the given document is searched using the completely expanded regular expressions of the extensible grammar expressions to determine if the unstructured data in the document matches one or more of the extensible grammar expressions in the set.

Matching using the regular expressions of the set of extensible grammar expressions enables all of the overlap between the potential variables and all of the possible contexts in the sentences to be accounted for. However, it should be appreciated that small variations may change the meaning of the sentence and therefore the match should fail. The advantageousness of the extensible grammar expressions is that they are very brittle. Therefore, small variations will result in a break so that information is not extracted. For example, a press release may say “revenue was five million dollars less than it was last year. Accordingly, the revenue is not five million dollars and a match concerning revenue should be broke by the phrase “less than it was last year.”

Matching is generally performed from the beginning of the sentence. However, extensible grammar expression matching may not start at the beginning of the document. In one implementation, the first sentence is not matched from the first word. In addition, it is not required that a given extensible grammar expression match the entire sentence. However, if the sentence continues with a modifier such as “related to” the match may be discarded. For example, if the sentence was “revenue in Q4 2009 was five million dollars related to . . . ” In such case the company's total revenue was not five million dollars. Instead, the value is for a particular project, division or the like.

At 260, one or more sets of information matching the regular expressions of the set of extensible grammar expressions are extracted using one or more heuristics. The information may be extracted from the metadata corresponding to the given parameter variables for the given sentence. In one embodiment, the heuristics include a plurality of rules based upon a plurality of types. For example, if there is one type modifier that applies to one identifier in a sentence and it is incompatible with one that applies to all of the identifiers, then the local type modifier takes precedent. Type modifiers that are structured as subordinate clauses, appearing before the first identifier apply to all the identifiers. If only the first identifier has any kind of modifier, then it applies to everything. Closing statements inherit type modifier of opening statements. Type modifiers for net income also apply to their per-share. Commas and the AND variable may be used to divide the sentence up into clauses that are owned by given identifiers. Therefore, type modifiers within a second clause go with their given identifier in the section. For example, if the sentence was “the company announces non-GAPP net income of five million dollars and operation income of five million dollars.” The second value is operating income and the first value is non-GAPP. If there are no comas or the variable AND, then it matters whether it is a subordinate clause.

In order to improve performance, heuristics may determine whether particular extensible grammar expressions or identifiers can apply anywhere in the document. If they don't appear in the document then the applicable extensible grammar expressions are not used. Similarly, for individual sentences.

At 270, the one or more sets of extracted information are output. In one embodiment, the extracted information is stored on one or more computing device readable media. For example, the extracted information may be stored in a data structure in the memory (e.g., hard disk drive) of a computer. In other embodiments, the extracted information is output to a printer or display connected to the computer. In yet other embodiments, the extracted information is output to one or more other computer applications. For example, extracted information concerning a corporate earnings report may be output to a stock trading application for use in arbitrage trading or the like.

In one implementation, financial data may be extracted from corporate financial results with a very high degree of accuracy and substantially faster than conventional methods. In tests, the complete expanded regular expressions have achieved automated extracted results with substantially a 99.9% or greater accuracy, within 10 seconds or less. As a result, an entity utilizing the extracted data can value the stock and make applicable trades potentially before other traders.

Embodiments may also include identifying types in a given document. The types can appear anywhere because they are less structurally constrained than the other parts of the sentence. For example, if the document includes the sentence “On a non-GAPP basis, Acme corporation today announced that Q4 2009 revenue, net income and earnings-per-share were ten million dollars, five million dollars and 55 cents respectively.” In such case, the non-GAPP is applied to the revenue, net income and earnings-per-share. In contrast, if the sentence was “Acme Corporation today announced that Q4 2009 revenue was ten million dollars, earnings-per-share were 55 cents and non-GAPP net income was five million dollars.” In such case, non-GAPP type modifier only applies to the net income. In an exemplary implementation, a extensible grammar expression may be generated for unstructured data in a corporate financial statement related to the period, earnings, net income, dividend, guidance, numerical types and/or the like.

Embodiments may also include identifying section headers in a given document. One or more sections of a document may be dedicated to a particular subject, such as the performance of a division within a company. In such case, one or more extensible grammar expressions are utilized to identify section headers. If a section header is identified, one or more types associated with the given header are extracted and applied to the text within the section. In one implementation, the types within the section are de-prioritized and the type associated with the section header is applied to the section. For example, within a section, the text may state that revenue for asset management is a given amount. However, asset management may be a division of the company and therefore the given amount is not the revenue for the company, but is instead the revenue for the asset management division. The identification of the section may allow the revenue value in the section to be extracted for the division and not the company as a whole.

Embodiments may also include determining one or more numerical types. One or more extensible grammar expressions may be utilized to identify the one or more numerical types. The numerical types may include numbers, currency, percentage, per-share, duration, date, month, year, time, telephone number, uniform resource locator (URL), trading volume, and/or the like.

Embodiments may also include determining the time period used in a given document. One or more extensible grammar expressions may be utilized to identify time periods. For example, the extensible grammar expressions may search for month and quarter, fourth quarter and year end, second quarter and first half, third quarter and nine-months, identify the quarter but not the year, represent the current quarter but which do not identify the value of the current quarter, year-ago quarter, and/or the like.

In one embodiment, there may also be one or more extensible grammar expressions in which the time period is implied. For example, the financial statement may state that “Today we announce revenue of five million dollars.” In such case, it is substantially likely that it is for the current quarter. Therefore, if the quarter is known, it is substantially likely that the exemplary sentence is for the known quarter. Therefore, a extensible grammar expression that matches the sentence does not extract the value of the current quarter from the sentence, but instead the current quarter may be implied.

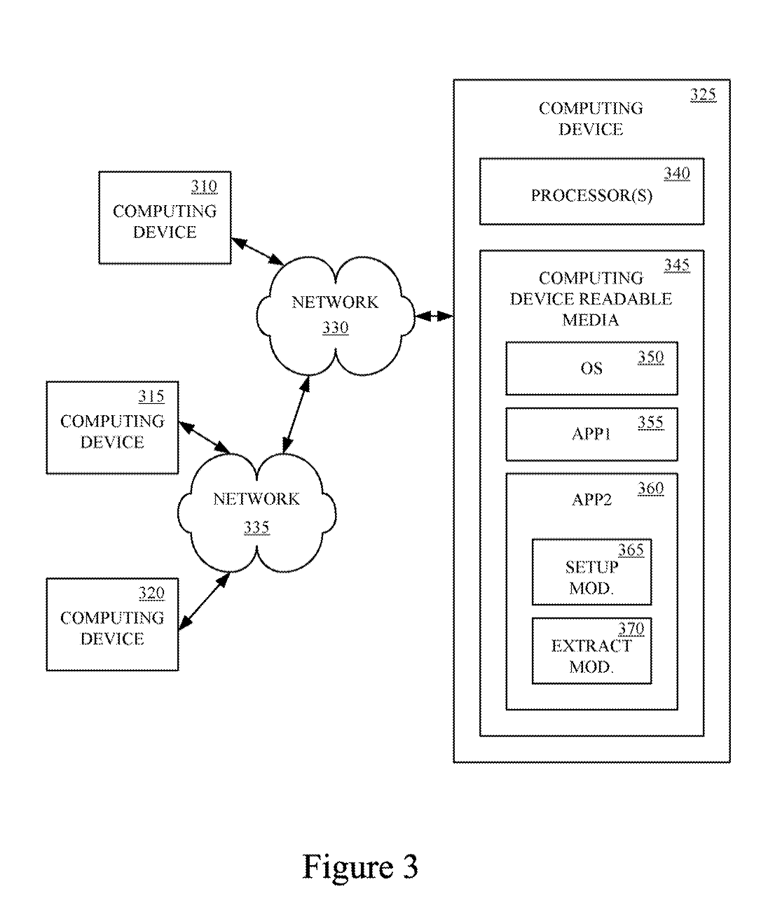

Referring now to FIG. 3, an exemplary computing environment for implementing embodiments of the present technology is shown. The computing environment may include a plurality of computing devices 310-325 communicatively coupled together by one or more networks 330, 335. The computing devices 310-325 may include personal computers (PC), servers, client computers, laptop computers, distributed computer systems, mainframe computers, and/or the like. The networks 330, 335 may include the internet, intranet, wide area network (WAN), local area network (LAN), and/or the like.

It is appreciated that the exemplary computing environment may include additional devices and/or subsystems. Furthermore, all of the illustrated devices and/or subsystems need not be present to practice the present technology. The devices and/or subsystems may also be interconnected in different ways. It should further be noted that the computing environment or one or more computing devices may have some, most or all of its functionality supplanted by a distributed computing system having a large number of dispersed computing nodes, such as would be the case where the functionality of the computing system or one or more computing devices is partly or wholly executed using a cloud computing environment. The general operation of the computing environment is readily known in the art and therefore is not discussed in further detail.

Each computing device 325 includes one or more processors 340 and one or more computing device readable media (e.g., computer memory) 345. The processors may be discrete microprocessors, multi-core processors, or the like. The one or more processors 340 execute computing device executable instructions stored in the one or more computing device readable media 345 to implement an operating system 350 and one or more applications, routines, module, utilities, routines and/or the like 355, 360. One or more processors 340 in one or more computing device 325 may execute computing device executable instructions to implement a regular expression setup module 365 and a regular expression extraction module 370.

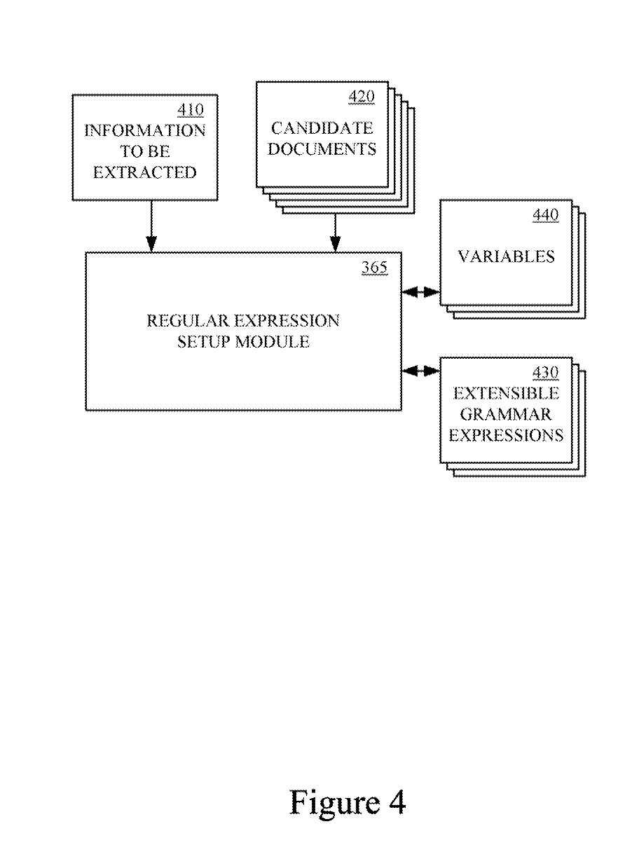

Referring now to FIG. 4, a regular expression setup module 365, in accordance with one embodiment of the present technology, is shown. The regular expression setup module 365 receives information to be extracted 410 and a plurality of candidate documents including unstructured data 420. The regular expression setup module 365 may condition the plurality of candidate documents by ignoring capitalization, replacing hyphens with spaces, stripping out commas and semicolons, and/or one or more words depending upon the subject of the document. The regular expression setup module 365 generates a plurality of extensible grammar expressions 430 from the plurality of candidate documents 420. The extensible grammar expressions 430 are generated by determining the allowed forms and variances of sentences. Generating the extensible grammar expressions 430 may include replacing words and strings with the applicable word substitution variables 440, replacing parameter values with applicable parameter variables and/or abstracting out optional and/or unnecessary words. There may be hundreds or more allowed extensible grammar expressions 430 with varying levels of complexity, that are recognized for describing all the allowed forms of the information expressed in sentence form (e.g., non-structured data).

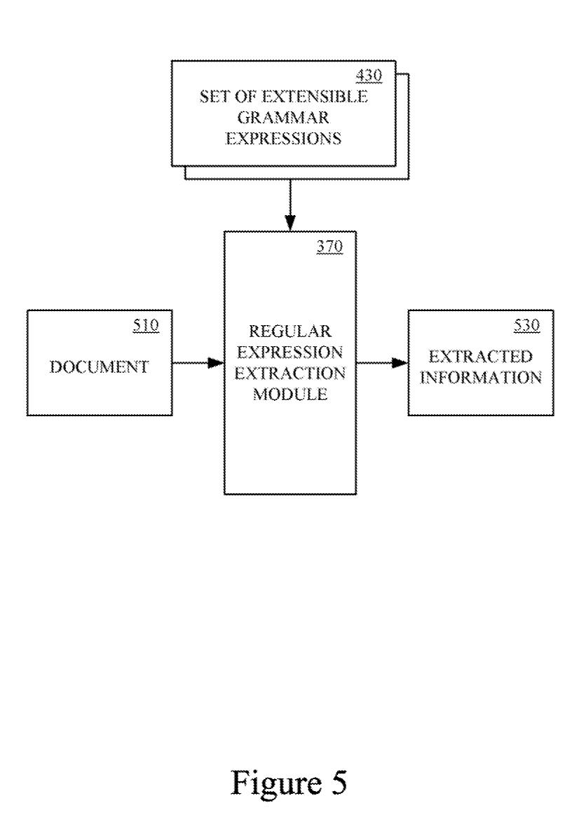

Referring now to FIG. 5, a regular expression extraction module 370, in accordance with one embodiment of the present technology, is shown. The regular expression extraction module 370 receives one or more extensible grammar expressions 430, wherein the regular expression of the extensible grammar expressions searches for a set of information. The regular expression extraction module 370 also receives a given document including unstructured data 510. The regular expression extraction module 370 may pre-process the given document by replacing discrete values with recognized parameter variables and storing the value of the parameter in metadata associated with the particular parameter variable. The regular expression extraction module 370 tokenizes the given document by replacing one or more words with corresponding potential word tokens. The regular expression extraction module 370 then searches the pre-processed and tokenized document 510 using the regular expressions 430 to determine if the unstructured data in the documents matches one or more extensible grammar expressions. If the data in the document matches, the regular expression extraction module 370 extracts 530 one or more sets of information from the unstructured data using one or more heuristics.

Embodiments of the present technology enable structuring of unstructured data. The data is advantageously structured by searching a document using one or more regular expressions to extract information. The regular expressions are advantageously generated by specifying a plurality of extensible grammar expressions, wherein each extensible grammar expression includes a plurality of variables and one or more regular expression operands. The extensible grammar expressions each give a concise description of a set of elements therein, without having to list all elements, and all possible instantiations. The extensible grammar expressions and/or variables are readily understood and modified. Furthermore, updating a variable advantageously updates all the extensible grammar expressions and/or regular expressions that utilize the updated variable without having to change the regular expressions of the extensible grammar expressions.

References within the specification to “one embodiment” or “an embodiment” are intended to indicate that a particular feature, structure, or characteristic described in connection with the embodiment is included in at least one embodiment of the present technology. The appearance of the phrase “in one embodiment” in various places within the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments. In this application, the use of the disjunctive is intended to include the conjunctive. The use of definite or indefinite articles is not intended to indicate cardinality. In particular, a reference to “the” object or “a” object is intended to denote also one of a possible plurality of such objects.

The foregoing descriptions of specific embodiments of the present technology have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is intended that the scope of the invention be defined by the claims appended hereto and their equivalents.

What is claimed is:

1. A method comprising:
receiving a plurality of extensible grammar expressions, wherein each extensible grammar expression includes a regular expression that searches for a set of information;
receiving a given document including unstructured data;
tokenizing the given document;
searching the tokenized given document using the regular expressions to determine if the unstructured data in the document matches one or more of the extensible grammar expressions;
extracting one or more sets of information from the unstructured data using one or more heuristics; and
outputting the one or more sets of extracted information.

2. The method according to claim 1, wherein the regular expressions comprise a comprehensive list of sentences abstracted into a plurality of grammatical structures based on allowed forms and variances of the sentences.

3. The method according to claim 1, wherein each extensible grammar expression includes a plurality of variables and one or more regular expression operands arranged in an allowed form of a grammatical structure.

4. The method according to claim 3, wherein the regular expressions of the set of extensible grammar expressions can identify the contexts within a sentence to determine which variable a given word fits under.

5. The method according to claim 1, wherein tokenizing the given document comprises replacing each of one or more words with corresponding potential word tokens.

6. The method according to claim 5, wherein one or more of the plurality of variables comprise a word substitution variable including a plurality of functionally equivalent words.

7. The method according to claim 1, further comprising:
receiving information to be extracted;
receiving a plurality of candidate documents including unstructured data;
generating a plurality of extensible grammar expressions for the information from the unstructured data of the plurality of candidate documents; and
outputting the plurality of extensible grammar expressions.

8. One or more computing device readable media including a first plurality of computing device executable instructions that when executed by a processing unit implement a plurality of extensible grammar expressions, wherein each extensible grammar expression includes a regular expression to match corresponding unstructured data in a document.

9. The one or more computing device readable media of claim 8, wherein each extensible grammar expression comprises a plurality of variables and a plurality of regular expression operands.

10. The one or more computing device readable media of claim 9, including a third plurality of computing device executable instructions that when executed by the processing unit implement the plurality of variables, wherein each variable comprises a variable identifier and one or more from the group of one or more words, one or more phrases, and one or more variables.

11. The one or more computing device readable media of claim 10, wherein one or more of said plurality of variables further includes one or more regular expression operands.

12. The one or more computing device readable media of claim 1 including a fourth plurality of computing device executable instructions that when executed by the processing unit implement a plurality of potential word tokens, wherein each word token includes a regular expression comprising one or more words, one or more phrases and one or more regular expression operands.

13. One or more computing device readable media including a plurality of computing device executable instructions which when executed by a processing unit implement a method comprising:
receiving a plurality of extensible grammar expressions, wherein each extensible grammar expression includes a regular expression that searches for a set of information;
receiving a given document including unstructured data;
pre-processing the given document;
tokenizing the given document; searching the pre-processed and tokenized document using the regular expressions to determine if the unstructured data in the document matches one or more of the extensible grammar expressions;
extracting one or more sets of information from the unstructured data using one or more heuristics; and
outputting the one or more sets of extracted information.

14. The one or more computing device readable media including the plurality of computing device executable instructions which when executed by the processing unit implement the method of claim 13, wherein the regular expressions comprise a comprehensive list of sentences abstracted into a plurality of extensible grammar expressions based on allowed forms and variances of the sentences.

15. The one or more computing device readable media including the plurality of computing device executable instructions which when executed by the processing unit implement the method of claim 13, wherein each extensible grammar expression includes calls to a plurality of variables joined by one or more regular expression operands.

16. The one or more computing device readable media including the plurality of computing device executable instructions which when executed by the processing unit implement the method of claim 13, wherein each variable includes one or more functionally equivalent words joined by one or more regular expression operands.

17. The one or more computing device readable media including the plurality of computing device executable instructions which when executed by the processing unit implement the method of claim 16, wherein each variable further includes one or more functionally equivalent phrases joined by one or more regular expression operands.

18. The one or more computing device readable media including the plurality of computing device executable instructions which when executed by the processing unit implement the method of claim 17, wherein each variable further includes one or more calls to other variables joined by one or more regular expression operands.

19. The one or more computing device readable media including the plurality of computing device executable instructions which when executed by the processing unit implement the method of claim 17, wherein:
pre-processing the given document includes replacing each of one or more parameters with corresponding parameter tokens; and
tokenizing the given document includes replacing each of one or more words with corresponding potential word tokens.

20. The one or more computing device readable media including the plurality of computing device executable instructions which when executed by the processing unit implement the method of claim 13, further comprising:
identifying the information to be extracted;
receiving a plurality of candidate documents including unstructured data;
generating the plurality of extensible grammar expressions for the information from the unstructured data of the plurality of candidate documents; and
outputting the one or more regular expressions.
